(19) United States
(12) Patent Application Publication
(10) Pub. No.: US 2024/0039638 A1
(43) Pub. Date: Feb. 1, 2024

(54) COMPLEX-WAVEFRONT PHOTONIC TRANSCEIVER PROCESSOR

(71) Applicant: California Institute of Technology, Pasadena, CA (US)

(72) Inventors: Aroutin Khachaturian, Pasadena, CA (US); Parham Porsandeh Khial, Pasadena, CA (US); Seyed Ali Hajimiri, Pasadena, CA (US)

(73) Assignee: California Institute of Technology, Pasadena, CA (US)

(21) Appl. No.: 18/363,283

(22) Filed: Aug. 1, 2023

Related U.S. Application Data
(60) Provisional application No. 63/394,228, filed on Aug. 1, 2022.

(51) Int. Cl. H04B 10/61; H04B 10/70

(52) U.S. Cl. CPC H04B 10/61; H04B 10/70

(57) ABSTRACT

A complex-wavefront photonic transceiver including a coherent source; a complex transmitter waveform generator programmable to modulate a first portion of the coherent electromagnetic radiation, when received from the coherent source, to form a complex waveform comprising at least a pre-distortion to compensate for, or an adaptive beamforming to determine, a distortion of the complex waveform caused by at least the transceiver or during transmission of the complex waveform to a receiver aperture, the receiver aperture outputting receiver signals in response thereto; and a transmitter aperture for transmitting the complex waveform when received from the complex transmitter waveform generator. The transceiver further includes a receiver processor programmable to determine a phase and amplitude of the complex waveform, when received on the receiver aperture, from a combination of the received signals with a second portion of the electromagnetic radiation.

### CROSS REFERENCE TO RELATED APPLICATION(S)

This application claims the benefit under 35 U.S.C. Section 119(e) of the following co-pending and commonly-assigned application(s):
U.S. Provisional Application Ser. No. 63/394,228, filed on Aug. 1, 2022, by Aroutin Khachaturian, Parham Porsandeh Khial and Seyed Ali Hajimiri, entitled “COMPLEX-WAVEFRONT PHOTONIC TRANSCEIVER PROCESSOR,” docket number CIT 8858-P;
   which application(s) is/are incorporated by reference herein.

### BACKGROUND OF THE INVENTION

### 1 Field of the Invention

This invention relates to a complex-wavefront photonic transceiver processor, a method for providing same and a method for operating same.

### 2. Description of the Related Art

(This application references a number of different publications as indicated throughout the specification by one or more reference numbers in brackets, e.g., [x]. A list of these different publications ordered according to these reference numbers can be found below in the section entitled “References,” wherein each of these publications is incorporated by reference.)

A high-resolution and precision electromagnetic perception system enables robotic and autonomous systems to be more aware of their surroundings, which improves their performance and increases their reliability and safety. In many applications, various sensors such as coherent photonic 3D imagers, RADARs, CMOS sensors, etc., are combined to produce a multi-modal imager with improved reliability and precision. In particular, coherent photonic systems offer higher sensitivity by operating at the quantum shot-noise limit and can perform spectral analysis to determine material types. The challenge with photonic perception systems is their susceptibility to various sources of distortions such as fog, dust, or heat which disrupts the beam quality.

### SUMMARY OF THE INVENTION

The inventive subject matter of the present invention can be embodied in many ways including, but not limited to, the following examples.

1. A device comprising:
a complex-wavefront photonic transceiver, comprising:
a coherent source;
a transmitter comprising:
a complex transmitter waveform generator programmable to modulate a first portion of coherent electromagnetic radiation, when received from the coherent source, to form a complex waveform comprising at least a pre-distortion, to compensate for, or an adaptive beamforming used to determine, a distortion of the complex waveform caused by at least the transceiver or during transmission of the complex waveform through a distortion medium to a receiver aperture; and
a transmitter aperture for transmitting the complex waveform when received from the complex transmitter waveform generator; and
   a receiver comprising:
the receiver aperture outputting receiver signals in response to the complex waveform; and
a receiver processor programmable to determine a transmitted phase and transmitted amplitude of the complex waveform, when received on the receiver aperture, from a combination of the received signals with a second portion of the electromagnetic radiation.

2. The device of example 1, wherein:
the complex waveform generator comprises:

a power splitter splitting a plurality of signal beams from the first portion of coherent electromagnetic radiation when received from a coherent source; and
a plurality of modulators downstream of the power splitter, the modulators configurable to modulate a phase and amplitude of one or more of the signal beams when received from the power splitter; and
the receiver further comprises a mixer mixing the second portion of the coherent electromagnetic radiation with the received signals to form a plurality of mixed signals; and
the receiver processor is programmable to determine, from the mixed signals, the transmitted phase and the transmitted amplitude of the complex waveform after interaction of the complex waveform with the distortion medium.

3. The device of example 2, wherein the transceiver further comprises a circuit controlling the modulators to form the signal beams with the pre-distortion comprising pre-distorted phases and pre-distorted amplitudes that compensate for the distortion caused by at least one of the distortion medium, a manufacturing imperfection of the device, a temperature and/or stress induced variations of the device, an interaction with a target being imaged using the complex wavefront, or limitations in the field of view of the apertures.

4. The device of example 3, further comprising one or more calibration processors coupled to the receiver processor and/or the complex transmitter waveform generator, wherein the signal beams comprise calibration signals having predetermined phases and predetermined amplitudes, and
the calibration processors determine the distortion comprising one or more changes in the predetermined phases and the predetermined amplitudes, and
the circuit applies the pre-distortion determined from the changes.

5. The device of example 4, wherein the distortion comprises a phase shift and an amplitude shift that is canceled out by the pre-distorted phases and the pred-distorted amplitudes, respectively.

6. The device of example 3, wherein:
the complex transmitter waveform generator comprises one or more calibration circuits downstream and/or upstream of the modulators, and
the calibration circuits comprise at least one of:
one or more detectors connected to measure one or more of the amplitudes of one or more of the signal beams, or
one or more in-phase (I) and quadrature (Q) interferometers connected to obtain measurements of one or more phases of one or more of the signal beams, and
the circuit confirms or controls the modulation of the pre-distorted phases and the pre-distorted amplitudes using the measurements as feedback.

7. The device of example 6, wherein the detectors consist essentially of log 2(N) detectors for N signal beams.

8. The device of example 6, wherein, for N>3 signal beams:
the calibration circuits connect to the signal beams via a first node, a second node, and a third node,
the first node is connected to the detectors comprising a single detector,
the second node is connected to a first one of the interferometers, and
the third node is connected to a second one of the interferometers, and
the calibration circuits cycle each of one or more of the signal beams to the three nodes.

9. The device of example 4, wherein the coherent wavefront comprising the calibration signals:
is transmitted to a series of different points and the circuit determines the distortion comprising spatial variations in the phase and the amplitude between the different points, and comprises a series of spectrally modulated waves (different in frequencies and/or relative phase) and the circuit determines the distortion comprising spectral shifts in the phases and the amplitudes.

10. The device of example 9, wherein the modulators apply the pre-distortion according to:
calibration coefficients and matrices, or
corrections obtained from linear or nonlinear regression and optimization methods, or
corrections obtained from a machine learning algorithm.

11. A communication system comprising the device of example 2 comprising one or more transmitters and one or more a receivers, wherein:
the signal beams carry data, and
the modulators are configured to frequency encode the signals so that the transceiver can send and receive different data from different directions simultaneously.

12. The device of example 1 further comprising the transmitter and the receiver co-located on a single substrate.

13. The device of example 2, comprising one or more transmitters and one or more receivers co-located on a single substrate, wherein the modulators and a coupling between the receiver and the transmitter modulate the signal beams to form the complex wavefront.

14. The device of example 2, wherein the modulators modulate the signal beams to allow generation and processing of the complex wavefront comprising any arbitrary wavefront.

15. An imaging and/or beam forming system comprising the device of example 2, comprising an optical phased array comprising:
the modulators modulating the signal beams; and
the aperture coherently combining the signal beams;
so as to form the complex wavefront and/or independently steer the signal beams.

16. The device of example 2, wherein the apertures comprise an array of antennas or grating couplers and the power splitter comprises an array of waveguides.

17. The device of example 2, wherein the modulators comprise:
a cascaded amplitude modulator and a phase modulator, or
an array of IQ modulators (SSB modulators).

18. The device of example 1, wherein the receiver comprises:
a power splitter splitting the second portion of the coherent electromagnetic radiation into a plurality of reference signals and the mixer comprising an array of coherent IQ mixers connected to mix the received signals with the reference signals to form the mixed signals comprising downconverted IQ signals;
a modulator modulating the mixed signals to form modulated signals compensating for unwanted distortions caused by the receiver; and
one or more calibration circuits measuring the phase and amplitude of the modulated signals to control or confirm the compensating.

19. A photonic integrated circuit and/or one or more chips comprising the device of example 1.

20. A photonic integrated circuit, comprising at least one of:
a transmitter and/or receiver comprising:
a power splitter comprising splitters positioned to split a plurality of beams (signal beams or reference beams) from an input comprising a first portion of coherent electromagnetic radiation received from a coherent source; and
a plurality of modulators positioned downstream of the power splitter to modulate a phase and amplitude of one or more of the beams received from the power splitter wherein:
the transmitter comprises a transmitter aperture positioned to transmit output electromagnetic radiation comprising the signal beams; and
the receiver comprises:
a receiver aperture positioned to output a plurality of received signals in response to the output electromagnetic radiation comprising the signal beams having interacted with a distortion medium; and
a mixer having a first input positioned to receive a second portion of the coherent electromagnetic radiation, a second input positioned to receive the received signals, wherein the mixer mixes the second portion with the received signals to form a plurality of mixed signals; and
   a processor programmable to determine, from the mixed signals, a transmitted phase and a transmitted amplitude of one or more of the signal beams after interaction of the signal beams with a distortion medium; and
a circuit for controlling the modulators to form the signal beams with a pre-distortion comprising pre-distorted phases and pre-distorted amplitudes that compensate for a distortion caused by at least one of the distortion medium, a manufacturing imperfection of the device, a temperature and/or stress induced variations of the device, an interaction with a target being imaged using the complex wavefront, or limitations in the field of view of the apertures.

21. A silicon photonic transceiver architecture that is capable of estimating the non-idealities of the photonic propagation medium for coherent imaging and data transmission applications. The silicon photonic transceiver architecture is capable of correcting for coherent artifacts such as speckle noise as well as for correcting for atmospheric turbulence and distortions that degrade the photonic beam quality.

### BRIEF DESCRIPTION OF THE DRAWINGS

Referring now to the drawings in which like reference numbers represent corresponding parts throughout:

FIGS. 1(a) and 1(b) are schematics illustrating the effects of optical path distortions and degradation of the receiver photonic beam, wherein FIG. 1(a) is a schematic of a conventional photonic transceiver imaging application, and FIG. 1(b) is a schematic of a conventional photonic transceiver point-to-point transceiver system.

FIGS. 2(a) and 2(b) are schematics illustrating correcting for channel distortion effects using the complex-wavefront transceiver using adaptive beamforming and pre-distortion, wherein FIG. 2(a) is a schematic of a complex-wavefront transceiver for an imaging application with pre-distortion for high-resolution imaging and detection, and FIG. 2(b) is a schematic of a complex-wavefront transceiver for distortion-free point-to-point transceiver applications.

FIGS. 3(a) and 3(b) are schematics providing a complex-wavefront transceiver overview, wherein FIG. 3(a) is a schematic of a complex wavefront processor on the transmitter path generates any arbitrary complex wavefront radiated through the transmitter aperture. A complex wavefront processor on the receiver mixes the received wavefront with the complex reference LO channel. FIG. 3(b) is a schematic illustrating details of one exemplary complex-wavefront transceiver. Complex transmitters and receivers enable the realization of any arbitrary complex wavefront.

FIGS. 4(a) and 4(b) illustrate complex signal modulation, wherein FIG. 4(a) illustrates complex signal modulation via cascaded phase and amplitude modulation, and, FIG. 4(b) illustrates complex signal modulation via a single-side-band (SSB) modulator, which is an amplitude (I) and phase (Q) modulator, known as an IQ modulator.

FIG. 5 is a schematic of a Complex Digital Receiver example, wherein IQ down-converted signals allow complete wavefront reconstruction.

FIGS. 6(a) and 6(b) are schematics illustrating On-Chip Calibration, wherein FIG. 6(a) illustrates a Tunable 1:N Power Splitter. Only log₂(N) monitor diodes are required. FIG. 6(b) illustrates Complex Modulator Calibration. A power sniffer and an IQ interferometric sniffer enable full calibration of complex signals. A tunable power splitter enables complete control of all N complex outputs using only three shared electrical nodes.

FIG. 7 is a schematic of a basic optical phased array (OPA) beamforming, wherein only one transmit beam is processed at a time by the receiver.

FIG. 8 is a schematic illustrating dual transmitter OPA beamforming, wherein the receiver processes both transmitted beams simultaneously.

FIG. 9 is a schematic illustrating simplified dual transmitter OPA beamforming, wherein the receiver processes both transmitted beams simultaneously. The frequency encoded transmitter signals are combined on-chip and radiated through a common aperture.

FIG. 10 is a schematic of a complex OPA transmitter using SSB complex signal modulations.

FIG. 11(a) is a schematic of a complex OPA transmitter using SSB complex signal modulations, FIG. 11(b) are Far-field beam patterns of transmit and receive channels at angles from 0° to 180°, and FIG. 11(c) are Far-field beam patterns of the combined transmit and receive channels at angles from 0° to 180°.

FIG. 12 is an image of a Silicon photonic implementation of the co-prime complex-wavefront transceiver.

FIGS. 13 and 14 are flowcharts that illustrate the steps for making and operating a complex-wavefront photonic transceiver.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### 1 INTRODUCTION

As noted above, the challenge with photonic perception systems is their susceptibility to various sources of distortions, such as fog, dust, or heat, which disrupt beam quality. In imaging applications, these distortions reduce the resolution of the image, while in communication applications, these distortions affect the maximum data rate that can be transferred between two photonic transceivers.

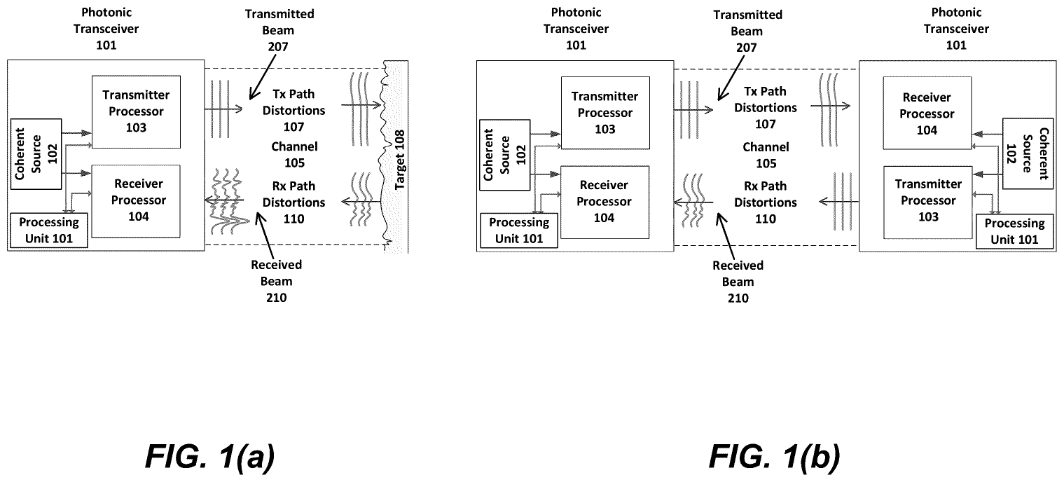

FIGS. 1(a) and 1(b) are schematics illustrating the effects of optical path distortions and degradation of photonic beams, wherein FIG. 1(a) is a schematic of a conventional photonic transceiver 101 used for imaging applications, including a coherent source 102, processing unit 102, transmitter processor 103 and receiver processor 104, and FIG. 1(b) is a schematic of the conventional photonic transceiver 101 used for point-to-point communications, with the same components as FIG. 1(a).

In the conventional imaging photonic transceiver 101 of FIG. 1(a), a coherent source 102, such as a laser, generates two beams one as transmitter signal for the transmitter processor and one as a reference local oscillator (LO) channel or signal, and a processing unit 101 generates control signals for the transmitter processor 103 and receiver processor 104. In a channel 105, the transmitter processor 103 generates an ideal transmitted beam 106 that is subject to transmit (Tx) path distortion 107 between the conventional photonic transceiver 101 and a target 108. The target 108 generates a received beam 109 in the channel 105 that is subject to receive (Rx) path distortion 110 between the target 108 and the receiver processor 104, wherein the Rx path distortion 110 may comprise distortion due to the target 108 surface roughness and/or channel 105 distortions. The beam 109 may comprise a reflection of beam 106, the beam 109 may comprise a response to beam 106, and/or the beam 109 may comprise a signal independent of beam 106.

In the conventional communications photonic transceiver 101 of FIG. 1(b), two conventional photonic transceivers 101 communicate across the channel 105, using the same components as FIG. 1(a), subject to Tx path distortion 107 and Rx path distortion 110, which in this example comprises channel 105 distortions.

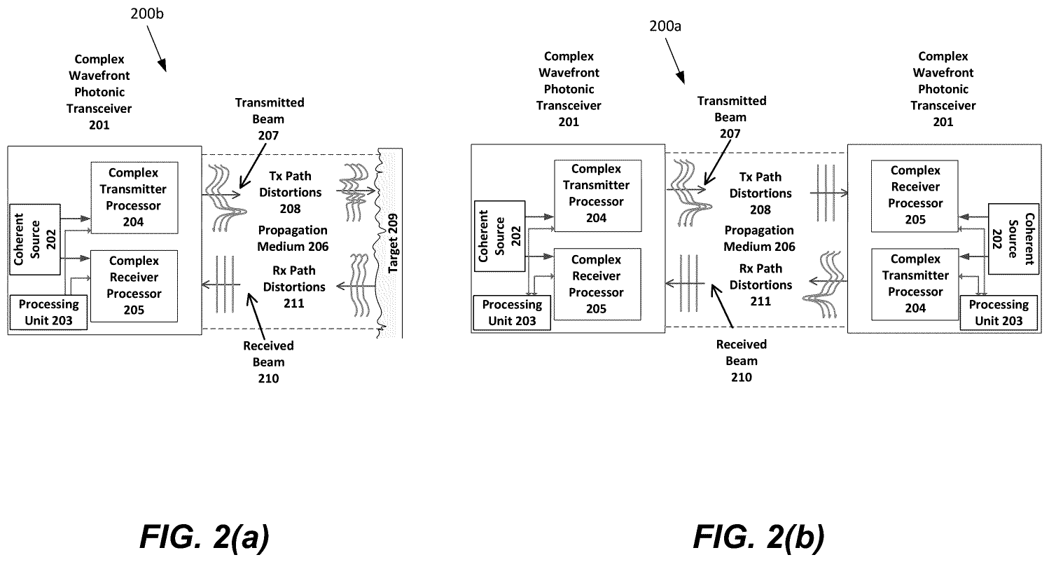

This disclosure presents a novel complex-wavefront photonic transceiver architecture, as shown in FIGS. 2(a) and 2(b), that can compensate for transmission propagation medium distortion. In free-space applications, the propagation medium is the atmosphere. In medical imaging applications, the propagation medium is biological tissue. The system can eliminate or minimize photonic propagation medium distortions and improve the overall imaging performance on its own or as a part of multi-modal sensing apparatus.

FIGS. 2(a) and 2(b) are schematics of a complex-wavefront transceiver 201 using adaptive beamforming and pre-distortion to correct for channel distortion effects, wherein FIG. 2(a) is a schematic of the complex-wavefront transceiver 201 used in an imaging application with pre-distortion for high-resolution imaging and detection, and FIG. 2(b) is a schematic of the complex-wavefront transceiver 201 used for distortion-free point-to-point communications applications.

In the complex-wavefront imaging photonic transceiver 201 of FIG. 2(a), a coherent source 202 generates a reference LO channel, and a processing unit 203 generates control signals for a complex transmitter processor 204 and a complex receiver processor 205, and receives feedback signals therefrom. In a propagation medium 206, the complex transmitter processor 204 generates an ideal transmitted beam 207 that is subject to Tx path distortion 208 between the complex transmitter processor 204 and a target 209. The target 209 generates a received beam 210 in the propagation medium 206 that is subject to Rx path distortion 211 between the target 209 and the complex receiver processor 205, wherein the Rx path distortion 211 may comprise distortion due to the target 209 surface roughness and/or propagation medium 206 distortions. The beam 210 may comprise a reflection of beam 207, the beam 210 may comprise a response to beam 207, and/or the beam 210 may be independent of beam 207.

In the complex-wavefront communications transceiver 201 of FIG. 2(b), two complex-wavefront photonic transceivers 201 communicate across the propagation medium 206, using the same components as FIG. 2(a), subject to Tx path distortion 208 and Rx path distortion 211, which in this example comprises propagation medium 206 distortions.

1.1 Example Integrated Photonic Propagation-Medium Estimation

In RF and mm-wave applications, both the phase and amplitude of the electromagnetic waves can be precisely controlled. The transmitted complex wavefront, distorted by the propagation medium, can be fully recovered by the receiver aperture. Afterward, the transmitter and receiver can transmit and receive various calibration waveforms (sometimes multi-beam projections) to compensate for the wavefront distortions, improving the channel bandwidth for high-speed data transmission applications or high-resolution radar applications.

The challenge with photonic transceiver beamforming and calibration is that due to the small size of the carrier signal's wavelength, the useful field-of-view (FOV) for the aperture is very limited for more than a hundred optical antennas [2]. Furthermore, no photonic detector has sufficient bandwidth to recover the bandwidth of the optical carrier signal which is required for wavefront calibration. The solution of this invention is a photonic coherent transceiver system capable of compensating for any propagation medium distortions in the aperture's full FOV.

1.2 Example Propagation-Medium-Estimating Solution

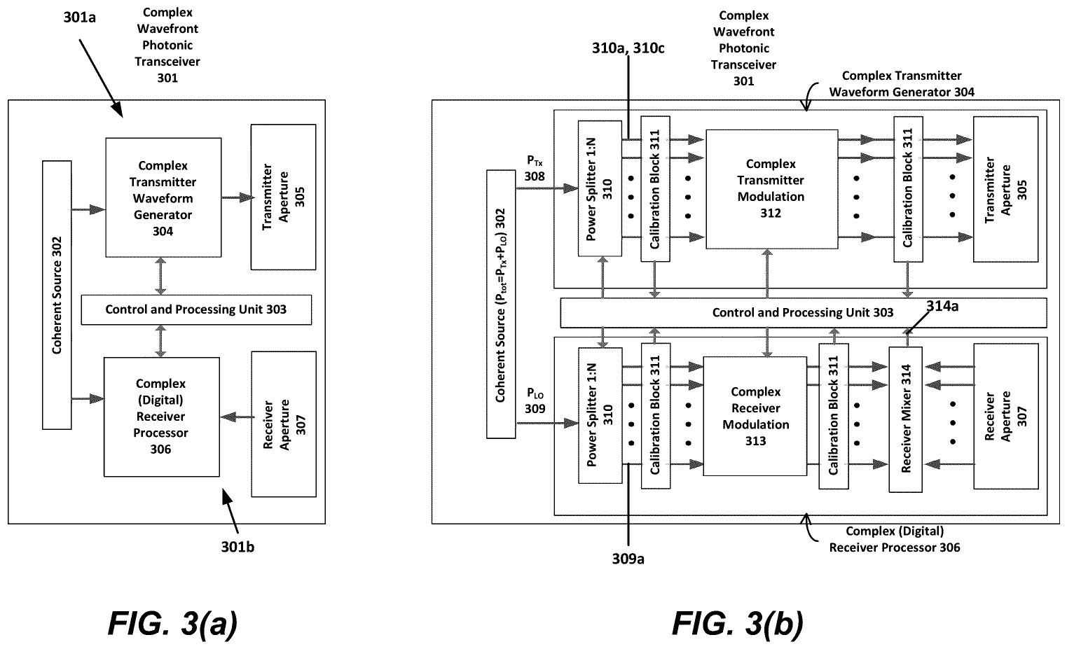

This disclosure describes a novel integrated photonic transceiver architecture capable of generating any arbitrary complex wavefront and processing any arbitrary complex wavefront, as shown in FIGS. 3(a) and 3(b), which are schematics providing an overview of a complex-wavefront transceiver.

FIG. 3(a) illustrates a complex-wavefront photonic transceiver 301 that includes a coherent source 302 that generates a complex reference LO channel, a control and processing unit 303, a complex transmitter waveform generator 304, a transmitter aperture 305, a complex (digital) receiver processor 306, and a receiver aperture 307. The complex transmitter waveform generator 304 generates any arbitrary complex wavefront radiated through the transmitter aperture 305. The complex (digital) receiver processor 306 mixes the wavefront from the receiver aperture 307 with the complex reference LO channel from the coherent source 302.

FIG. 3(b) further illustrates the components of the complex-wavefront photonic transceiver 301. The coherent source 302 generates a reference LO channel with a beam pattern comprised of P_{Tx} 308 and P_{LO} 309, wherein Pₜₒₜ=P_{Tx}+P_{LO}. The complex transmitter wavefront generator processor 304 includes a power splitter 1:N 310, calibration blocks 311, and a complex transmitter modulation 312, as well as the transmitter aperture 305. The complex (digital) receiver processor 306 includes a power splitter 1:N 310, calibration blocks 311, a complex receiver modulation 313, and a receiver mixer 314, as well as the receiver aperture 307. The complex wavefront photonic transceiver 301 enables the realization of any arbitrary complex wavefront.

The ability to generate a complex transceiver wavefront enables propagation medium estimation and compensation for various propagation medium distortions. Moreover, the architecture described herein overcomes the integrated photonic FOV-beamwidth trade-off without sacrificing the system signal-to-noise ratio. In addition, the architecture includes novel all-integrated calibration blocks 311 to account for fabrication imperfections as well as temperature and stress-induced on-chip performance variations. The calibration blocks 311 can be implemented with reduced system complexity requiring O(log₂(N)) interconnect nodes for O(N) signal paths. Finally, several exemplary channel estimation methodologies are introduced and discussed for the architecture described herein.

### 2 EXAMPLE BUILDING BLOCKS

In one embodiment of this architecture, the complex waveform processing can be performed on-chip in an integrated photonic platform, as shown in FIG. 3(b).

The light coupled into the chip can be dynamically split into several optical channels. In a dielectric platform, these optical channels will be dielectric waveguides. Afterward, the optical signal can be adjusted in phase and amplitude (complex modulated by the complex transmitter modulation 312 and complex receiver modulation 313) for both the complex transmitter waveform generator 304 and complex (digital) receiver processor 306. Both the complex transmitter waveform generator 304 and complex (digital) receiver processor 306 can be calibrated using the integrated calibration blocks 311.

2.1 Example Complex Signal Modulation

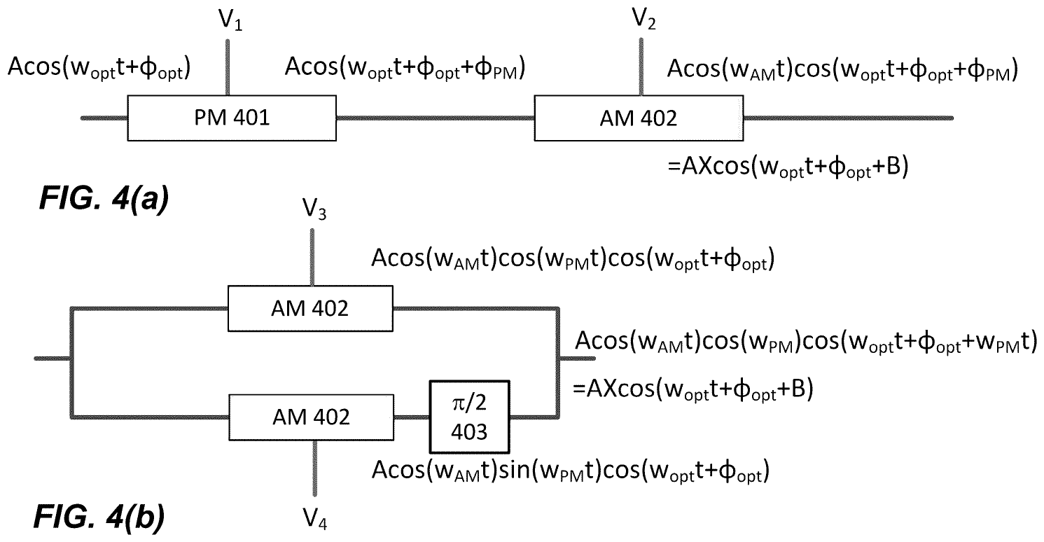

For each signal path, it is possible to cascade phase and amplitude modulators to program the phase and amplitude of each signal to any arbitrary value, as shown in FIG. 4(a).

Alternatively, a single-sideband (SSB) modulator (also known as an IQ modulator) can be used to IQ modulate the signal to the desired complex value within a single block, as shown in FIG. 4(b).

FIGS. 4(a) and 4(b) illustrate complex signal modulation, wherein FIG. 4(a) illustrates complex signal modulation via cascaded phase and amplitude modulation, and

FIG. 4(b) illustrates complex signal modulation via SSB modulator, which is an in-phase (I) (I) and quadrature (Q) modulator, wherein:
PM is a phase modulator 401,
AM is an amplitude modulator 402,
π/2 is a 90° phase shifter 403,
V1, V2, V3, V4 are voltage control signals,
A is the amplitude,
B is a phase shift,
X is a constant,
wₒₚₜ is the frequency of the signal beams/optical carrier,
ϕₒₚₜ is the phase of the optical carrier,
wpm is the frequency of the phase modulated signal,
ϕ_{PM} is the phase of the phase modulated signal,
w_{AM} is the frequency of the amplitude modulated signal,
ϕ_{AM} is the phase of the amplitude modulated signal, and
t is time.

An array of these SSB modulators in a transmitter can form any complex wavefront when connected to photonic radiators. Alternatively, in a receiver, an array of these SSB modulators in the reference path can form a complex and adaptive receiving aperture.

2.2 Example Digital Complex Receiver

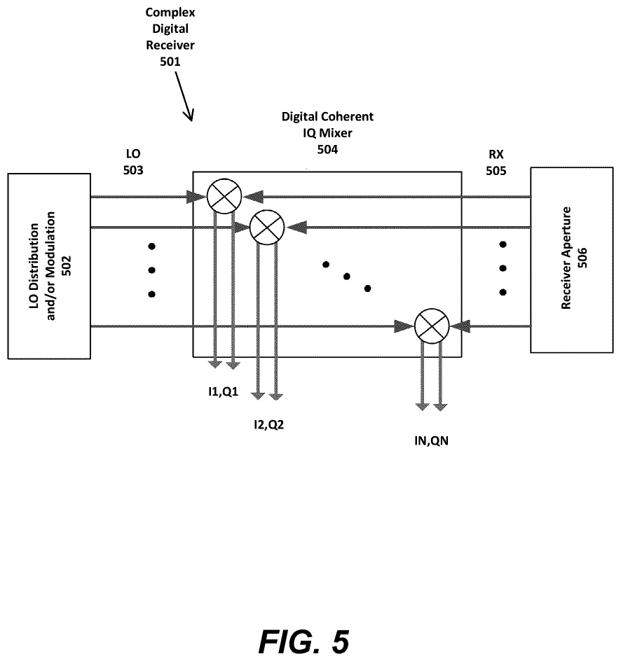

While direct detection mechanisms measure the intensity or power of the signal, and heterodyne detection schemes measure the relative phase of the signal with respect to the reference LO channel, an IQ unit cell, using a 90° hybrid coupler and balanced detectors, can measure both the amplitude (I) and phase (Q) of the received signals with respect to the reference LO channel [1]. An array of such IQ receivers can extract the relative amplitude I and phase Q of any receiving wavefront, as shown in FIG. 5. This allows the receiver to reconstruct the complex wavefront impinged on the aperture in post-processing.

FIG. 5 is a schematic of a complex digital receiver 501, including LO distribution and/or modulation 502, that generates the reference LO channel 503, a digital coherent IQ mixer 504 that down-converts the Rx signal 504 from the receiver aperture 505 using the reference LO channel 503, wherein down-converted signals comprise I₁, Q₁; I₂, Q₂; . . . ; and I_{N}, Q_{N}, and the Iₓ, Qₓ down-converted signals allow for complete wavefront reconstruction.

2.3 Example On-Chip Calibration Cell

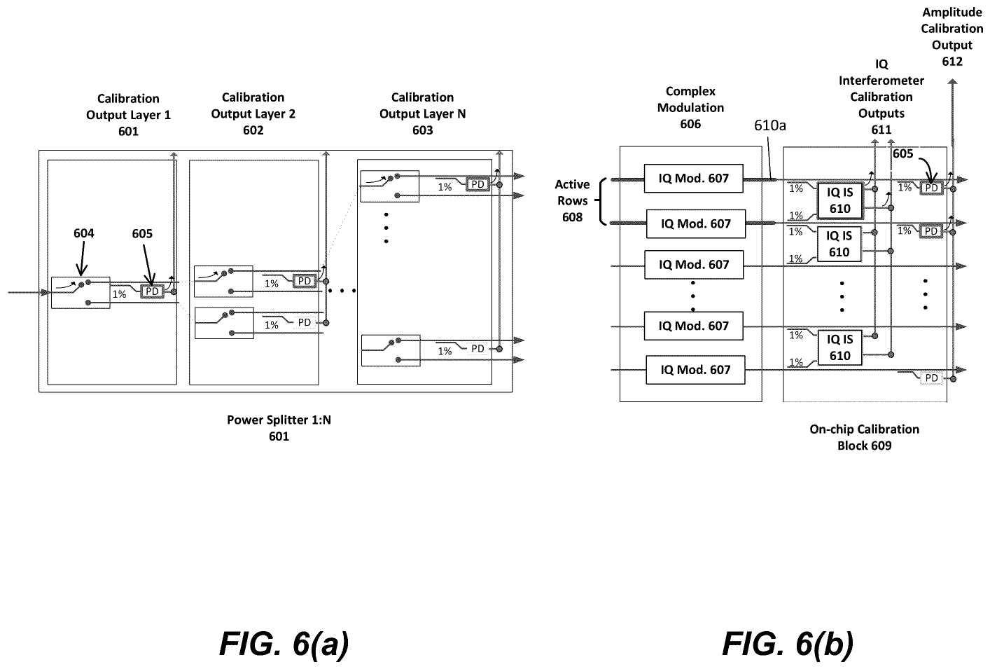

A power detector or intensity sniffer (1% power tap to a detector) can measure the amplitude of each signal path. An interferometer sniffer (mixing 1% taps from two channels) can measure the relative phase between two paths within a π uncertainty. Here, an IQ interferometer sniffer (mixing 1% tap of two channels both in phase and in quadrature) can resolve the relative phase of two paths within a uncertainty, as shown in FIGS. 6(a) and 6(b).

FIG. 6(a) is a schematic illustrating a tunable 1:N power splitter 601 including calibration output layer 1 601, calibration output layer 2 602, . . . , and calibration output layer N 603. In the calibration output layers 601, 602, 603, the signal is split by switches 604, and a power detector or sniffer 605 comprises a monitor diode. Only log₂(N) monitor diodes are required. The tunable power splitter 1:N 601 enables complete control of all N complex outputs using only three shared electrical nodes.

FIG. 6(b) is a schematic illustrating a complex modulation 606, including IQ modulators 607, that are selected for one or more active rows 608, wherein each of the rows correspond to one of the 1:N outputs of the tunable 1:N power splitter 601. The output from the IQ modulators 607 is then input into an on-chip calibration block 609 comprised of IQ interferometer sniffers 610 generating IQ interferometer calibration outputs 611. Each output from the IQ modulators 607 is also processed by power detectors 605, which generate an amplitude calibration output 612. The IQ interferometric sniffers 610 and power detectors 605 enable full calibration of complex signals.

If all channels have power detectors 605 and IQ interferometer sniffers 610, any change in the relative amplitude and phase of the channels can be monitored by the power detectors 605 and IQ interferometer sniffers 610, respectively. This can be used to calibrate for any deviation from ideal designed parameters. In addition, any modulation applied to the signal channels by the IQ modulators 607 can be measured and monitored to ensure that the exact desired complex wavefront is generated via the integrated IQ modulators 607.

The challenge with this solution is that for an N-channel system, N+2(N−1) control nodes (N for the power detectors 605 and 2(N−1) for the IQ interferometry sniffers 610) are required. This increases the system complexity. Since fabrication mismatches and the IQ modulators 607 can be calibrated once before first use, and device performance degradation can be compensated for (healed) cyclically, direct access to all 3N−2 nodes is not required. If a tunable amplitude distribution can arbitrarily distribute the optical power to the N-channel system, only three readout nodes are required. All intensity measurement nodes (i.e., power detectors 605), and in-phase and quadrature interference nodes (i.e., IQ interferometry sniffers 610) can be connected together on-chip and connected to the three readout nodes. Afterward, complex signal modulators and on-chip channels can be calibrated by diverting the optical power to a single channel for intensity measurement or to a pair of channels for IQ interferometry.

2.4 Example Arbitrary Complex Wavefront Generation

An array of liquid crystal amplitude modulators (AMs) and an array of liquid crystal phase modulators (PMs) can generate any arbitrary photonic wavefront. This solution is limited in FOV by the minimum pitch between the liquid crystal AMs and PMs. On the other hand, conventional uniform integrated optical phased arrays (OPAs) suffer from the same minimum pitch limitation. Contrary to liquid crystal arrays, integrated OPAs can operate at MHz and GHz frequencies. However, the minimum pitch requirement for OPA increases as the size of the aperture increases. This results in a much smaller useful FOV for the aperture. Sparse apertures can address this FOV issue at the cost of reduced beam efficiency. On the other hand, co-prime multi-beam transceiver beamforming methods can address the FOV challenge by co-designing the transmitter and receiver apertures to a particular specification to avoid aliasing.

Standard beamforming can be achieved if the relative phase between different transmitter channels/paths is incremented linearly with uniform amplitude distribution using PMs. The beam can be steered by adjusting the relative phase of the different transmitter channels. Instead of uniform amplitude distribution, amplitude apodization can reduce the side lobe levels (SLL) and improve beamforming performance. In addition, the wavefront can be arbitrarily programmed if individual transmitter channels have SSB modulators as discussed in 2.1. In this scheme, only O(3N+log₂(N)) control nodes are required for an N-element transmitter.

Using the complex signal modulation scheme shown in the 2.1, it is possible to generate an arbitrary wavefront within the FOV of the aperture. However, the arbitrary wavefront will be duplicated at other gratings lobes due to the grating lobes.

2.5 Example Arbitrary Complex Wavefront Receiver

Similar to the transmitter, a receiver can have an array of SSB modulators and a tunable combing tree (instead of a tunable splitter tree) to adjust the receiving wavefront arbitrarily. Alternatively, the reference signal can be phase and amplitude corrected for coherent receiver architectures to improve the overall system sensitivity. Using the complex signal processing described in 2.1, it is possible to receive an arbitrary adaptive wavefront within the FOV of the aperture (limited by the grating lobes). In addition, a digital receiver beamforming methodology can be used to apply the desired complex modulation to the signal in post-processing. As a result, the receiver can apply complex beam processing after signal sampling and digitization in post-processing.

2.6 Example Arbitrary Complex Wavefront Transceiver

The FOV restrictions are removed with a co-prime transceiver (having co-prime transmitter and receiver apertures) incorporating a complex transmitter and a complex (digital) receiver. The transceiver can generate any arbitrary transceiver beam pattern. The arbitrary complex beam pattern can be used for transmission medium estimation and distortion compensation.

### 3 EXAMPLE PHOTONIC COMPLEX-WAVEFRONT TRANSCEIVER

Within the FOV of the transmitter aperture, using the complex wavefront generation methods mentioned above, any complex wavefront can be generated. Within the FOV of the receiver, any receiver light can be complex using any desired complex adaptive receiver.

As a result, point-to-point communication systems using complex transmitters can transmit multiple photonic beams to multiple receivers, and complex receivers can receive and process multiple beams from different arrival directions. This results in the realization of high-efficiency complex-wavefront transceiver architecture.

3.1 Example Frequency Encoding of the Photonic Beams

Here, a methodology for frequency encoding of different transmit and receive beams is presented. This enables the transmitter and receivers to send/receive different data from different directions simultaneously. This can be used in high-speed data transmission applications where the transmitter and receiver can independently send/receive multiple streams of data in/from multiple directions. Multiple scanning beams can be encoded with identification tags for imaging applications to improve imaging resolution, signal isolation, and scan rate.

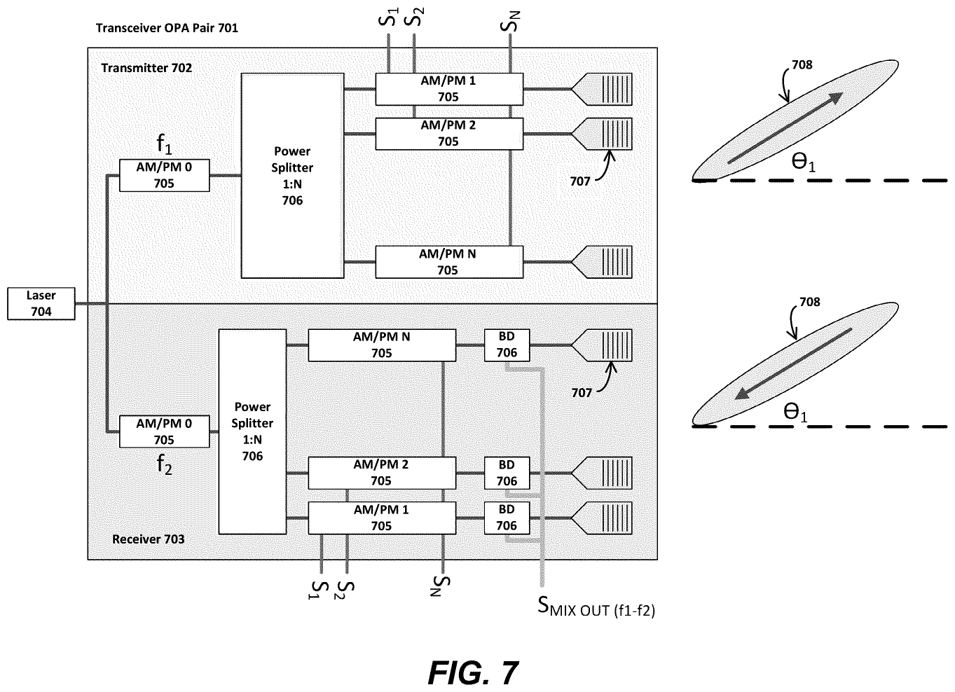

The frequency encoding scheme can be derived using the following simplified examples. As a point of reference, a simple transmitter and receiver OPA pair using tunable phase shifters can transmit and receive from a single direction at a given time, as shown in FIG. 7.

FIG. 7 is a schematic illustrating a transceiver OPA pair 701, including a transmitter 702 and a receiver 703, using tunable phase shifters that can transmit to and receive from a single direction at a given time.

The transceiver OPA pair 701 includes a laser source 704, amplitude modulators/phase modulators (AM/PM) 0 705, power splitters 1:N 706, AM/PM 1 705, AM/PM 2 705, . . . , AM/PM N 705, balanced detectors (BD) 706, and grating couplers 707. The AM/PM 0 703 generate f₁, f₂ signals for the power splitters 1:N 706. The AM/PM 1 705, AM/PM 2 705, . . . , AM/PM N 705 of the transmitter 702 modulate the outputs of the power splitter 1:N 706 with data signals S₁, S₂, . . . , S_{N} to generate a photonic beam. The transmitter 702 transmits the photonic beam with a lobe 708 at an angle of 01 at the grating coupler 707. The receiver 703 receives the photonic beam with a lobe 708 at an angle of 01 at the grating coupler 707. The AM/PM 1 705, AM/PM 2 705, . . . , AM/PM N 705 of the receiver 703 down-convert the photonic beam using the outputs of the power splitter 1:N 706 to generate the data signals S₁, S₂, S_{N}, while the BDs 706 together generate a mixed data signal S_{Mix Out (f1-f2)}.

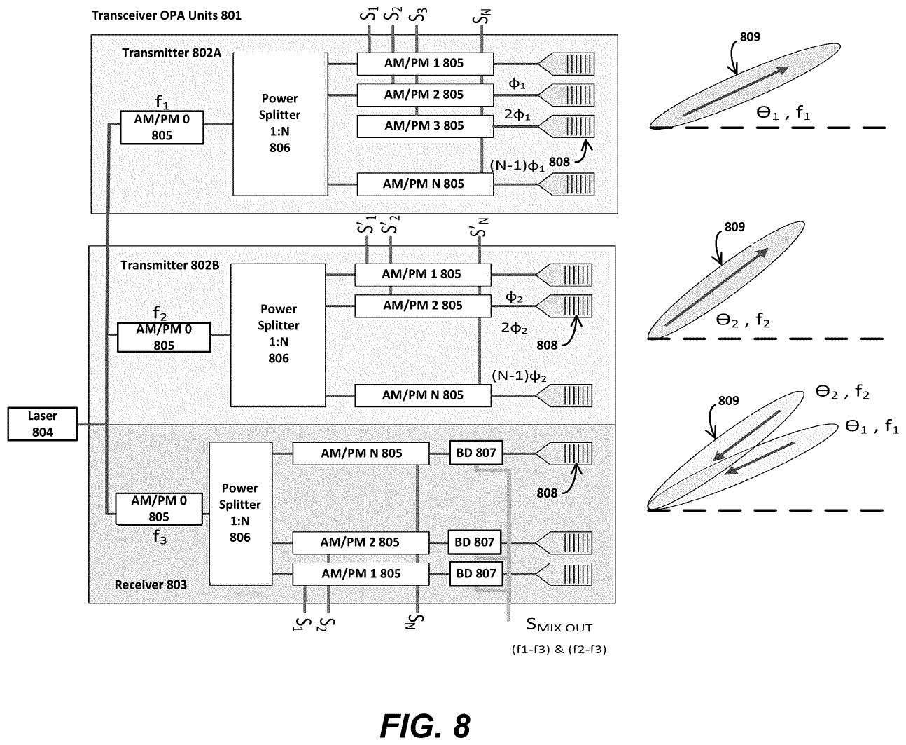

To increase the number of concurrent beams, transmitter and receiver OPA units may include two photonic transmitters combined with a single photonic receiver, as shown in FIG. 8.

FIG. 8 is a schematic illustrating a transceiver OPA unit 801, including two transmitters 802A, 802B, and a receiver 803. The transceiver OPA units 801 include a laser source 804, AM/PMs 805, power splitters 1:N 806, BDs 807, and grating couplers 808. The AM/PM 0 805 generate f₁, f₂, f₃ signals for the power splitters 1:N 806. The AM/PM 1 805, AM/PM 2 805, . . . , AM/PM N 805 of the transmitters 802A, 802B modulate the outputs of the power splitters 1:N 806 with data signals S₁, S₂, S_{N}, and signals S′₁, S′₂, . . . , S′_{N}, respectively, to generate photonic beams. The photonic beams generated by the AM/PM 1 805, AM/PM 2 805, . . . , AM/PM N 805 in the transmitters 802A, 802B are phase-shifted by 0, ϕ₁, 2ϕ₁, . . . , (N−1) and 0, ϕ₂, 2ϕ₂, . . . , (N−1)ϕ₂, respectively. The transmitters 802A, 802B transmit the photonic beams with lobes 809 at an angle of θ₁ for f₁ and an angle of θ₂ for f₂, respectively, at the grating couplers 808. The receiver 803 receives the photonic beams with lobes 809 at an angle of θ₁ for f₁ and an angle of θ₂ for f₂ at the grating couplers 808. The AM/PM 1 805, AM/PM 2 805, . . . , AM/PM N 805 of the receiver 803 down-convert the photonic beams using the output of the power splitter 1:N 806 to generate the data signals S₁, S₂, . . . , S_{N}, while the BDs 807 together generate a signal S_{Mix out (f1-f2)}. In this embodiment, the receiver 803 processes both transmitted beams 809 simultaneously. The individual transmitters 802A, 802B are frequency encoded at their input. The frequency encoding could be a data or an identification signal. In one exemplary scenario, the frequency encoding is basic amplitude modulation at frequency f₁ for transmitter 802A, f₂ for transmitter 802B, and f₃ for the receiver 803. The two transmitters 802A, 802B can be independently steered in different directions. If the receiver 803 is digital, the digitally reconstructed down-converted beam at frequency f₁-f₃ will correspond to the target reflected from the output of transmitter 802A and the reconstructed down-converted beam at frequency f₂-f₃ will correspond to the target reflected from the output of the transmitter 802B. This construct enables concurrent scanning of two independent transmitter 802A, 802B operations using a common aperture. Even if the receiver 803 is not digital but has two grating lobes 809, the photonic beams of the two transmitters 802A, 802B can align to different grating lobes 809 of the receiver 803 for the simultaneous scans of two different directions using a common receiver 803.

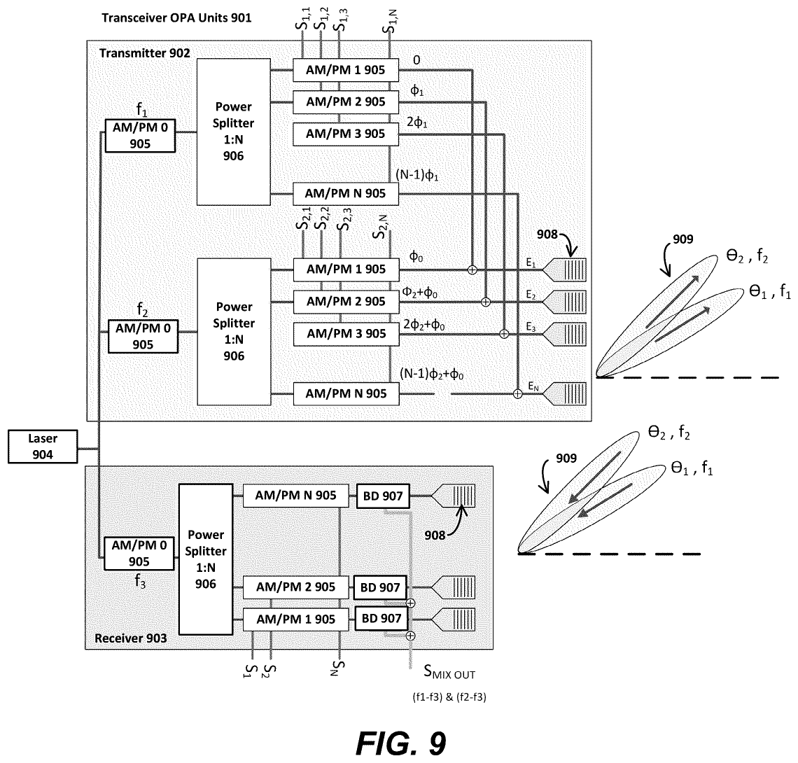

Instead of having two separate transmitters with separate phase modulation blocks and radiation blocks, the output of phase modulation channels can be coherently combined on-chip. As a result, two separate modulation blocks will radiate through the same radiation block (aperture), as shown in FIG. 9, which is a schematic illustrating simplified dual transmitter OPA beamforming, wherein the receiver processes both transmitted beams simultaneously. The frequency encoded transmitter signals are combined on-chip and radiated through a common aperture.

FIG. 9 is a schematic illustrating transceiver OPA units 901, including a transmitter 902 and a receiver 903, wherein the transmitter 902 coherently combines the output of two sets of phase modulation channels. The transceiver OPA units 901 include a laser source 904, AM/PMs 905, power splitters 1:N 906, BDs 907, and grating couplers 908. The AM/PM 0 905 generate f₁, f₂, f₃ signals for the power splitters 1:N 906. Two sets of the AM/PM 1 905, AM/PM 2 905, AM/PM 3 905, . . . , AM/PM N 905 in the transmitter 902 modulate the output of the power splitters 1:N 906 with data signals S_{1,1}, S_{1,2}, S_{1,3}, . . . , S_{1,N}, and signals S_{2,1}, S_{2,2}, S_{2,3}, . . . , S_{2,N}, respectively, to generate the photonic beams. The photonic beams generated by the two sets of the AM/PM 1 905, AM/PM 2 905, AM/PM 3 905, . . . , AM/PM N 905 in the transmitter 902 are phase-shifted by different amounts 0, ϕ₁, 2ϕ₁, . . . , (N−1)ϕ₁, and ϕ₀, ϕ₂+ϕ₀, 2ϕ₂+ϕ₀, . . . , (N−1)ϕ₂+ϕ₀, respectively, and then combined. The transmitter 902 transmits the photonic beams with lobes 909 at different angles of θ₁ for f₁ and θ₂ for f₂, respectively, at the grating couplers 908. The receiver 903 receives the photonic beams with lobes 909 at an angle of θ₁ for f₁ and θ₂ for f₂, respectively, at the grating couplers 908. The AM/PM 1 905, AM/PM 2 905, . . . , AM/PM N 905 of the receiver 903 down-convert the photonic beams using the output of the power splitter 1:N 906 to generate the data signals S₁, S₂, . . . , S_{N}, while the BDs 907 together generate a signal S_{Mix out (f1-f3) & (f1-2)}.

The architecture can simultaneously radiate different data encoded waveforms in different directions. Similarly, a receiver can be constructed using the same principle. Here, the output will have a plurality of down-converted mixed signals where each signal corresponds to a different direction.

3.2 Example Multi-Beam Frequency Encoding using a Single Architecture

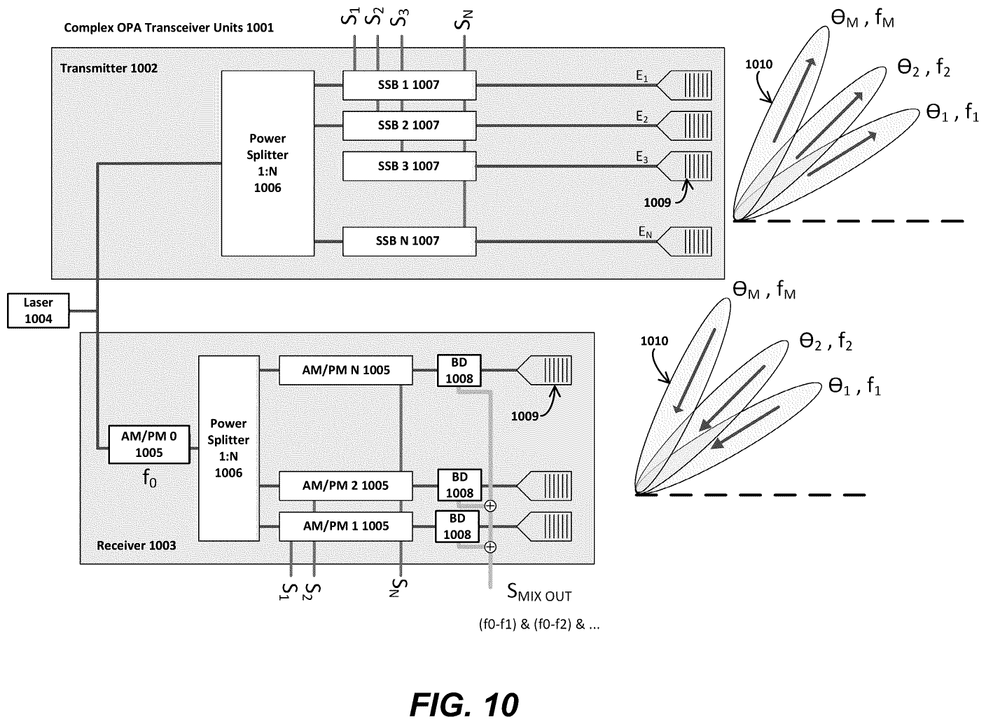

Instead of frequency encoding different wavefronts and combining on-chip as described in 3.1, a single SSB modulator can be used to generate the equivalent signal in a single unit since an SSB modulator can generate any arbitrary wavefront as described in 2.1. This is shown in FIG. 10, which is a schematic of complex OPA transceiver units using SSB complex signal modulations.

FIG. 10 is a schematic illustrating the complex OPA transceiver units 1001, including a transmitter 1002 and a receiver 1003. The complex transceiver OPA units 1001 include a laser source 1004, AM/PM 0 1005, AM/PM 1 1005, AM/PM 2 1005, . . . , AM/PM N 1005, power splitters 1:N 1006, SSB 1 1007, SSB 2 1007, SSB3 1007, . . . , SSB N 1007, BDs 1008, and grating couplers 1009. The AM/PM 0 1005 generates a f₀ signal for the power splitter 1:N 1006 in the receiver 1003. The SSB 1 1007, SSB 2 1007, SSB3 1007, . . . , SSB N 1007 in the transmitter 1002 modulate the output of the power splitter 1:N 1006 with data signals S₁, S₂, S₃, . . . , S_{N}, to generate photonic beams comprising E₁, E₂, E₃, . . . , E_{N}. The transmitter 1002 transmits the photonic beams with lobes 1010 at different angles of θ₁ for f₁, θ₂ for f₂, . . . , θ_{M} for f_{M}, respectively, at the grating couplers 1009. The receiver 1003 receives the photonic beams with lobes 1010 at different angles of θ₁ for f₁, θ₂ for f₂, . . . , θ_{M} for f_{M}, respectively, at the grating couplers 1009. The AM/PM 1 1005, AM/PM 2 1005, . . . , AM/PM N 1005 of the receiver 1003 down-convert the photonic beams using the output of the power splitter 1:N 1006 to generate the data signals S₁, S₂, . . . , S_{N}, while the BDs 1008 together generate a signal S_{Mix Out (f0-f1) & (f0-f2) & . . .} .

Using the SSB modulators, the complexity of generating a multi-beam photonic wavefront is transferred from the photonic front end to the electronic drive which requires complex IQ electrically modulated signals. This can be achieved using arbitrary wavefront generators (AWG).

A multi-beam frequency-encoded transmitter combined with a multi-beam frequency-encoded receiver gives full wavefront control of the aperture which can be used for propagation medium estimation and disturbance calibration.

3.3 Example Multi-Beam Radiator Limited Co-Prime Beamforming

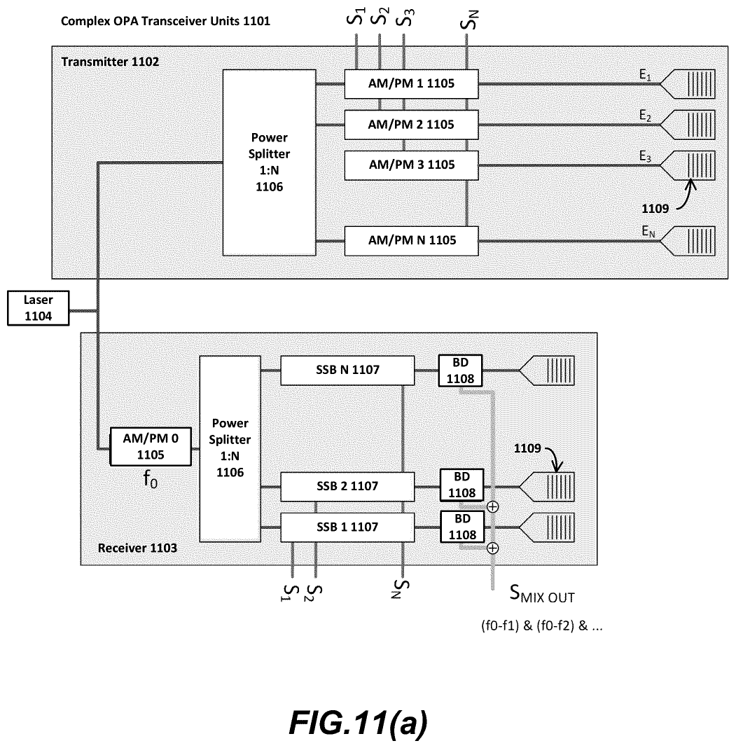

One method to achieve radiator-limited multi-beam beamforming is to use co-prime transceivers [2] where only one transmitter beam is observed by the receiver. Furthermore, a digital receiver can operate as a multi-input receiver, and capture multi-direction arrived signals. In addition, the multi-beam frequency-encoded architecture described in 3.2 can be combined with the digital receiver architecture to achieve a multi-beam transceiver operation as shown in FIG. 11(a), which is a schematic of a complex OPA transmitter using SSB complex signal modulations.

FIG. 11(a) is a schematic illustrating the complex OPA transceiver units 1101, including a transmitter 1102 and receiver 1103. The complex OPA transceiver units 1101 include a laser source 1104, AM/PM 0 1105, AM/PM 1 1105, AM/PM 2 1105, AM/PM 3 1105, . . . , AM/PM N 1105, power splitters 1:N 1106, SSB 1 1107, SSB 2 1107, . . . , SSB N 1107, BDs 1108, and grating couplers 1109. The AM/PM 0 1105 generates a f₀ signal for the power splitter 1:N 1106 in the receiver 1103. The AM/PM 1 1105, AM/PM 2 1105, . . . , AM/PM N 1005 in the transmitter 1002 modulate the output of the power splitter 1:N 1106 with data signals S₁, S₂, S₃, . . . , S_{N}, to generate photonic beams comprising E₁, E₂, E₃, . . . , E_{N} at the grating couplers 1109. The receiver 1003 receives the photonic beams at the grating couplers 1109, and the SSB 1 1107, SSB 2 1107, . . . , SSB N 1107 of the receiver 1103 down-convert the photonic beams using the output of the power splitter 1:N 1006 to generate the data signals S₁, S₂, . . . S_{N}, while the BDs 1108 together generate a signal S_{Mix out (f0-f1) & (f0-f2) & . . .} .

In this operation scenario, the multiple beams have split either post-processing or spectrally (different identifiers such as down-converted frequency components).

FIG. 11(b) are plots of transmit (Tx) and receive (Rx1, Rx2, Rx3) channels f₀, f₁, f₂, f₃, respectively, at angles from 0° to 180°, and FIG. 11(c) are plots of transceiver (TRx1, TRx2, TRx3) channels f₀-f₁, f₀-f₂, f₀-f₃, respectively, at angles from 0° to 180°.

The multi-beam complex wavefront transceiver, in conjunction with a multi-beam complex wavefront receiver, can operate with radiated-limited FOV. While there will be grating lobes due to the spacing of the transmitter elements, each set of transmitter grating lobes can be received by the complex wavefront receiver and processed separately. After collecting N transmitter beams at the receiver, the beams can be processed and compensated for separately. While these N identical transmitter paths (due to the grating lobes of the transmitter) experience unique distortions, the receiver can apply unique compensations to each path. As a result, the full transmitted wavefront can be fully compensated for by the receiver resulting in a full wavefront compensation in an integrated photonic system.

3.4 Example Lens-Assisted Complex-Wavefront Transceiver

In addition, physical lenses can be incorporated with various realizations of this architecture. These lenses can assist with a variety of functions such as beamforming, larger collection area, and improved resolution. The architectures described in sections 3.1-3.3 describe a lens-free realization of the complex-wavefront transceiver. In another embodiment, the transmitter and receiver apertures act as a focal plane array with a physical lens. Here, the wave and wavefront correction is assisted by a physical lens. In another embodiment of the architecture, cylindrical lenses can be used for a system that can calibrate for distortions in one direction by means of optical phased arrays and in the other direction by the means of a focal plane array. In another embodiment, spatial light modulators (phase and amplitude) can act as conformal lenses and amplitude modulators to achieve the same function as the OPA.

### 4. EXAMPLE COMPLEX-WAVEFRONT PHOTONIC PROPAGATION MEDIUM ESTIMATION

Using the aforementioned techniques and architectures, it is possible to extract the transmission channel's relative phase and amplitude factors by modifying the complex transmitter wavefront and capturing the complex received wavefront. For instance, known pilot signals (which could have time encoding data) can be transmitted from the transmitter aperture and the complex wavefront received can be used to infer the spatial phase and amplitude response of the propagation medium. With high-performing electro-optic components, a high-speed closed-loop bandwidth can be realized in an integrated fashion which will allow for real-time propagation medium distortion compensation.

4.1 Example Speckle Suppression and Image Enhancement

The complex wavefront manipulation enabled by the aperture will allow the structure to perform various compounding mechanisms such as wavelength, aperture, and polarization to average and suppress the speckles in the image. The architecture can be used to perform speckle imaging to achieve diffraction-limited resolution through the integrated imaging solution at long distances in the presence of atmospheric turbulence.

4.2 Example Distortion Compensation

To compensate for the various distortions through the atmosphere, a series of pilot beams can be transmitted through the propagation medium to measure the propagation medium distortions. In one embodiment, the receiver will capture a series of modulated points to measure their spatial variations. In another embodiment, a series of spectrally modulated waves (different in frequency, or relative phase) will be transmitted and captured by the receiver to measure the spectral effects of the propagation medium. If these spatial and spectral disturbances in the propagation medium can be corrected by simple calibration coefficients and matrices, the necessary wavefront corrections will be applied to the transmitter and the receiver. Alternatively, linear or nonlinear regression and optimization methods can be applied to apply optimal corrections to the transmitter and receiver to minimize and correct for the impacts of propagation medium non-idealities. Furthermore, artificial intelligence (AI) and machine learning (ML) algorithms such as deep learning and convolutional neural networks (CNN) can be applied to the propagation medium to correct for the propagation medium non-idealities.

4.3 Example Image Feature Extraction

For coherent imaging applications, the transceiver can estimate the shape of the target by examining the wavefront disturbances as a result of the reflection. This can be used to infer information about the target surface such as roughness, material type (by refractive index calculation via interferometry or resonance means), transparency, and geometric features such as edge and surface curvature.

### 5 EXAMPLE SILICON PHOTONIC IMPLEMENTATION

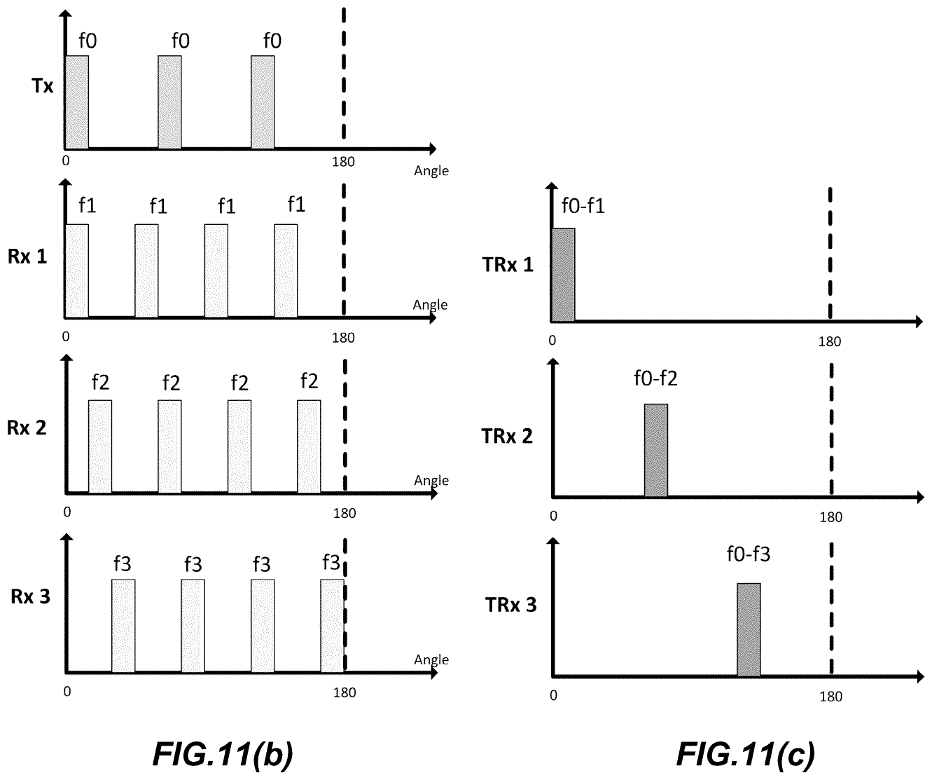

A photonic complex-wavefront transceiver was implemented in a standard silicon photonics process. The photonic complex-wavefront transceiver 1201 is shown in the photograph of FIG. 12, and includes a transmitter aperture 1202, calibration blocks 1203, complex transmitter modulator 1204, 1:16 power splitter with calibration 1205, transmitter input signal 1206, reference LO channel input 1207, wavefront phase control 1208, digital receiver IQ mixer 1209 and receiver aperture 1210.

Similar to FIG. 3(b), several calibration 1205 blocks enable the system's adaptive beamforming and on-chip calibration. A co-prime aperture, a complex transmitter, and a digital receiver enable full wavefront control within the FOV of the aperture.

### 6 ALTERNATIVES AND MODIFICATIONS

A number of alternatives and modifications are available for the present invention, as set forth below:
different devices and structures may be used in addition to those illustrated herein; and
different functions and steps may be used in addition to those illustrated herein.

### 7 PROCESS STEPS

a. Fabrication

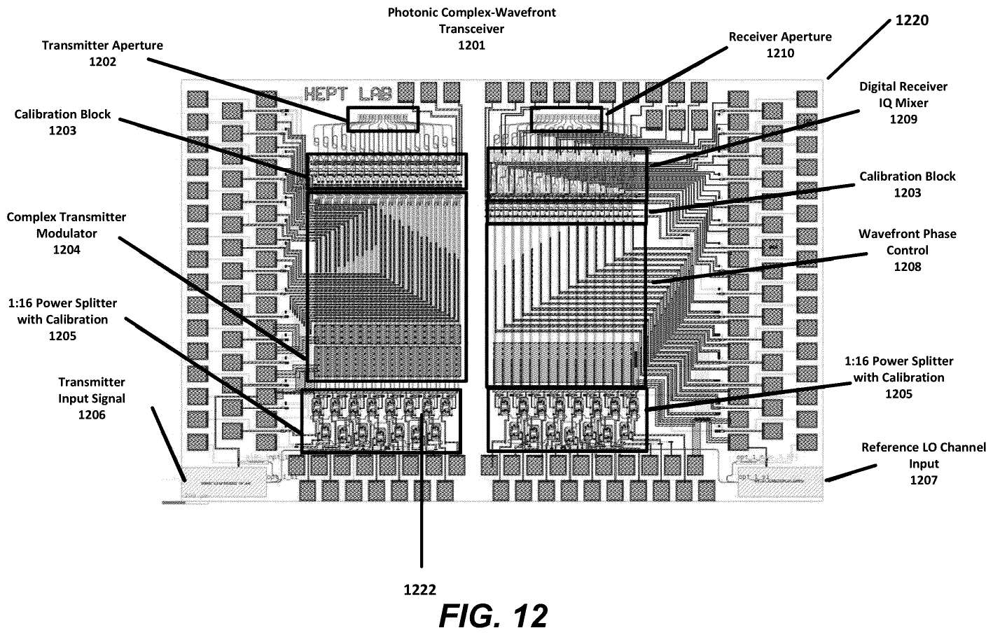

FIG. 13 is a flowchart illustrating a method of making a complex wavefront transceiver.

Block 1300 represents optionally obtaining a coherent source (e.g. laser), which may be coupled to the receiver and the transmitter.

Block 1302 (typo in the FIG. 13 1302r?) represents providing and or fabricating a transmitter comprising:
a complex transmitter waveform generator programmable to modulate a first portion of the coherent electromagnetic radiation, when received from the coherent source, to form a complex waveform comprising at least a pre-distortion or an adaptive beamforming to compensate for a distortion of the complex waveform caused by at least the transceiver or during transmission of the complex waveform to a receiver aperture, the receiver aperture outputting receiver signals in response thereto; and
a transmitter aperture for transmitting the complex waveform when received from the complex transmitter waveform generator; and Block 1304 represents providing and/or fabricating a receiver comprising the receiver aperture and a receiver processor programmable to determine a phase and amplitude of the complex waveform, when received on the receiver aperture, from a combination of the received signals with a second portion of the electromagnetic radiation.
   The receiver and transmitter can be manufactured in a semiconductor (e.g., silicon) using photolithography, for example.

Block 1306 represents the end result, a complex wavefront transceiver. The transceiver can be implemented in many ways including, but not limited to, the following (referring also to FIGS. 1-13).

1. A device comprising:
a complex-wavefront photonic transceiver (e.g., processor) 301, comprising:
a coherent source 302;
a transmitter 301a comprising:
a complex transmitter waveform generator 304 programmable/configurable to modulate a first portion 308 of coherent electromagnetic radiation, when received from the coherent source, to form a complex waveform 207 comprising at least a pre-distortion, to compensate for, or an adaptive beamforming used to determine, a distortion of the complex waveform caused by at least the transceiver or during transmission of the complex waveform through a distortion medium 206, 209 to a receiver aperture 307; and
a transmitter aperture 305 for transmitting the complex waveform 207 when received from the complex transmitter waveform generator 304; and
   a receiver 301b comprising:
the receiver aperture 307 outputting receiver signals in response to the complex waveform; and
a receiver processor 303, 306 programmable/configurable to determine a transmitted phase and transmitted amplitude of the complex waveform 207, when received on the receiver aperture, from a combination of the received signals with a second portion 309 of the electromagnetic radiation.

2. The device of example 1, wherein:
the complex waveform generator comprises:
a power splitter 310 splitting a plurality of signal beams 310a from the first portion of coherent electromagnetic radiation 308 when received from the coherent source 302; and
a plurality of modulators 312 downstream of the power splitter, the modulators configurable to modulate a phase and amplitude of one or more of the signal beams when received from the power splitter; and
the receiver further comprises a mixer 314 mixing the second portion of the coherent electromagnetic radiation 309 with the received signals to form a plurality of mixed signals 314a; and
the receiver processor 303, 306 is programmable to determine, from the mixed signals, the transmitted phase and the transmitted amplitude of the complex waveform after interaction of the complex waveform 207 with the distortion medium 206, 209.

3. The device of example 2, wherein the transceiver further comprises a circuit 303, 311 controlling the modulators 312 to form the signal beams with the pre-distortion comprising pre-distorted phases and pre-distorted amplitudes that compensate for the distortion caused by at least one of the distortion medium, a manufacturing imperfection of the device, a temperature and/or stress induced variations of the device, an interaction with a target 209 being imaged using the complex wavefront, or limitations in the field of view of the apertures 307, 305.

4. The device of example 3, further comprising one or more calibration processors 311 coupled to the receiver processor 306, 303 and/or the complex transmitter waveform generator 304, wherein the signal beams 310a comprise calibration signals having predetermined phases and predetermined amplitudes, and
the calibration processors 311 determine the distortion comprising one or more changes in the predetermined phases and the predetermined amplitudes, and
the circuit 311 and/or modulators 312 applies the pre-distortion determined from the changes.

5. The device of example 4, wherein the distortion comprises a phase shift and an amplitude shift that is canceled out by the pre-distorted phases and the pre-distorted amplitudes, respectively.

6. The device of example 3, wherein:
the complex transmitter waveform generator 304 comprises one or more calibration circuits 311 downstream and/or upstream of the modulators 312, and
the calibration circuits 311 comprise at least one of:
one or more detectors PD connected to measure one or more of the amplitudes of one or more of the signal beams, or
one or more in-phase (I) and quadrature (Q) interferometers 610 connected to obtain measurements of one or more phases of one or more of the signal beams, and
the circuit 311 confirms or controls the modulation of the pre-distorted phases and the pre-distorted amplitudes using the measurements as feedback.

7. The device of example 6, wherein the detectors 605 consist essentially of log 2(N) detectors for N signal beams 310.

8. The device of example 6, wherein, for N>3 signal beams:
the calibration circuits 311 connect to the signal beams 310a via nodes 610a comprising a first node, a second node, and a third node,
the first node is connected to the detectors 605 comprising a single detector,
the second node is connected to a first one of the interferometers 610, and
the third node is connected to a second one of the interferometers 610, and
the calibration circuits cycle each of one or more of the signal beams to the three nodes.

9. The device of example 4, wherein the coherent wavefront comprising the calibration signals:
is transmitted to a series of different points and the circuit 303 determines the distortion comprising spatial variations in the phase and the amplitude between the different points, and
comprises a series of spectrally modulated waves (different in frequencies and/or relative phase) and the circuit 303 determines the distortion comprising spectral shifts in the phases and the amplitudes.

10. The device of example 9, wherein the modulators 312 apply the pre-distortion according to:
calibration coefficients and matrices, or
corrections obtained from linear or nonlinear regression and optimization methods, or corrections obtained from a machine learning algorithm.

11. A communication system 200a comprising the device of example 2 comprising one or more transmitters 301a, 902 and one or more a receivers 301b, 903 wherein:
the signal beams 310a carry data, and
the modulators 312 are configured to frequency encode the signals so that the transceiver 301 can send and receive different data from different directions θ1, θ2 simultaneously.

12. The device of example 1 further comprising the transmitter and the receiver 301, 1201 co-located on a single substrate 1220.

13. The device of example 2, comprising one or more transmitters 301a, 902 and one or more receivers 903, 301b co-located on a single substrate, wherein the modulators and a coupling between the receiver and the transmitter modulate the signal beams to form the complex wavefront.

14. The device of example 2, wherein the modulators 312 are programmable or configurable modulate the signal beams 310a to allow generation and processing of the complex wavefront 207 comprising any arbitrary wavefront.

An imaging and/or beam forming system 200b comprising the device of example 2, comprising an optical phased array comprising:
the modulators 312 modulating the signal beams 310a; and
the aperture 305 coherently combining the signal beams;
so as to form the complex wavefront 207 and/or independently steer the signal beams 310, 909.

16. The device of example 2, wherein the apertures comprise an array of antennas or grating couplers 1109 and the power splitter comprises an array of waveguides 310c, 1222.

17. The device of example 2, wherein the modulators 312 comprise:
a cascaded amplitude modulator 402 and a phase modulator 401, or
an array of IQ modulators 607 (SSB modulators).

18. The device of example 1, wherein the receiver comprises:
a power splitter 310 splitting the second portion of the coherent electromagnetic radiation 309 into a plurality of reference signals 309a and the mixer comprising an array of coherent IQ mixers 504 connected to mix the received signals with the reference signals 309a, 503 to form the mixed signals comprising downconverted IQ signals IN, QN;
a modulator 313 modulating the mixed signals In, QN to form modulated signals compensating for unwanted distortions caused by the receiver 301b; and
one or more calibration circuits 311 measuring the phase and amplitude of the modulated signals to control or confirm the compensating.

19. A photonic integrated circuit 1201 and/or one or more chips 1201 comprising the device of example 1.

20. A photonic integrated circuit 1201, comprising at least one of:
a transmitter 301a and/or receiver 301b comprising:
a power splitter 1205, 310 comprising splitters positioned to split a plurality of beams (signal beams 310a or reference beams 309a) from an input 1206 comprising a first portion 308 of coherent electromagnetic radiation received from a coherent source 302; and
a plurality of modulators 1204, 312 positioned downstream of the power splitter 310 to modulate a phase and amplitude of one or more of the beams received from the power splitter wherein:
the transmitter 301a comprises a transmitter aperture 1202, 305 positioned to transmit output electromagnetic radiation comprising the signal beams; and
the receiver 301b comprises:
a receiver aperture 1210, 307 positioned to output a plurality of received signals in response to the output electromagnetic radiation 207 comprising the signal beams having interacted with a distortion medium 206; and
a mixer 1209 having a first input positioned to receive a second portion 309, 1207 of the coherent electromagnetic radiation, a second input positioned to receive the received signals, wherein the mixer mixes the second portion 309 with the received signals to form a plurality of mixed signals; and
   a processor 303, 306 programmable or configurable to determine, from the mixed signals, a transmitted phase and a transmitted amplitude of one or more of the signal beams 310a after interaction of the signal beams with the distortion medium 206; and
a circuit 1208, 303 for controlling the modulators to form the signal beams with a pre-distortion comprising pre-distorted phases and pre-distorted amplitudes that compensate for a distortion caused by at least one of the distortion medium, a manufacturing imperfection of the device, a temperature and/or stress induced variations of the device, an interaction with a target being imaged using the complex wavefront, or limitations in the field of view of the apertures 305, 307.

21. The device of any of the examples 1-20, wherein the phase modulator and amplitude modulator comprise a material (e.g., liquid crystal or nonlinear material, or electro-optic material, or thermo-optic material) thermally or electrically coupled to an electrode, wherein application of a voltage to the electrode controls, e.g., resistive heating, piezoelectric actuation, bi refringence, or electro-optic actuation of the material so as to control a phase or amplitude of the electromagnetic field (signal beam) passing through the material. Such modulators can be coupled to waveguides carrying the electromagnetic field (signal beam), e.g., in an interferometer, to further modulate the phase or amplitude.

Operation

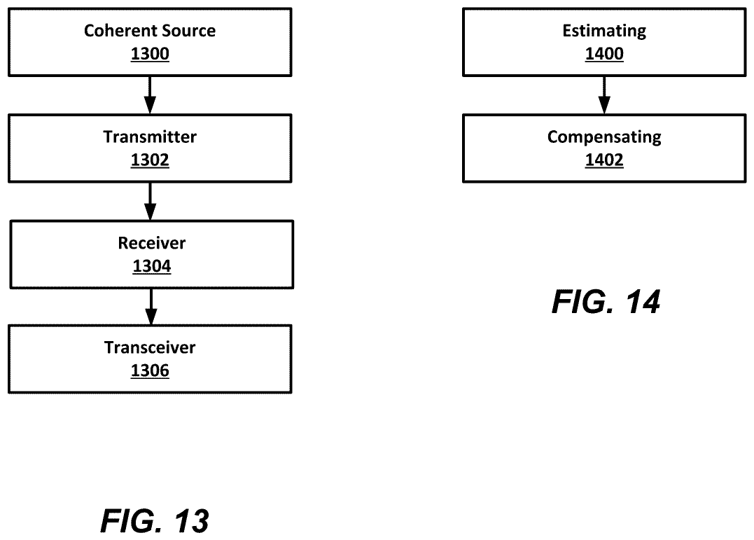

FIG. 14 illustrates a method, comprising the following steps.

Block 1400 represents estimating distortions to one or more photonic beams that occur in a photonic propagation medium or from a target, using a complex wavefront photonic transceiver processor (e.g., as described in any of the examples described herein).

Block 1402 compensating for the distortions to the photonic beam using the complex-wavefront photonic transceiver processor, wherein:
a coherent source generates coherent electromagnetic radiation;
one or more transmitters generate the photonic beams from the coherent electromagnetic radiation and modulated by encoded data signals, wherein the photonic beams have a complex-wavefront and are radiated using an aperture; and/or
one or more receivers accept the photonic beams from the aperture, and mix the photonic beams with a portion of the coherent electromagnetic radiation to obtain the encoded data signals.

The method can utilize the device of any of the examples 1-21 above.

### 8 REFERENCES

The following publications are incorporated by reference herein:
[1] Aroutin Khachaturian, Reza Fatemi, and Ali Hajimiri. IQ photonic receiver for coherent imaging with a scalable aperture. IEEE Open Journal of the Solid-State Circuits Society, 1:263-270, 2021. doi:10.1109/OJSSCS.2021.3113264.
[2] Aroutin Khachaturian, Reza Fatemi, and Ali Hajimiri. Achieving full grating-lobe-free field of view with low-complexity co-prime photonic beamforming transceivers. Photon. Res., 10(5):A66-A73, May 2022. doi:10.1364/PRJ.437518. URL http://opg.optica.org/prj/abstract.cfm?URI=prj-10-5-A66.

### 9 CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A device comprising:
a complex-wavefront photonic transceiver, comprising:
a coherent source;
a transmitter comprising:
a complex transmitter waveform generator programmable to modulate a first portion of coherent electromagnetic radiation, when received from the coherent source, to form a complex waveform comprising at least a pre-distortion, to compensate for, or an adaptive beamforming used to determine, a distortion of the complex waveform caused by at least the transceiver or during transmission of the complex waveform through a distortion medium to a receiver aperture; and
a transmitter aperture for transmitting the complex waveform when received from the complex transmitter waveform generator; and
a receiver comprising:
the receiver aperture outputting receiver signals in response to the complex waveform; and
a receiver processor programmable to determine a transmitted phase and transmitted amplitude of the complex waveform, when received on the receiver aperture, from a combination of the received signals with a second portion of the electromagnetic radiation.

2. The device of claim 1, wherein:
the complex waveform generator comprises:
a power splitter splitting a plurality of signal beams from the first portion of coherent electromagnetic radiation when received from a coherent source; and
a plurality of modulators downstream of the power splitter, the modulators configurable to modulate a phase and amplitude of one or more of the signal beams when received from the power splitter; and
the receiver further comprises a mixer mixing the second portion of the coherent electromagnetic radiation with the received signals to form a plurality of mixed signals; and
the receiver processor is programmable to determine, from the mixed signals, the transmitted phase and the transmitted amplitude of the complex waveform after interaction of the complex waveform with the distortion medium.

3. The device of claim 2, wherein the transceiver further comprises a circuit controlling the modulators to form the signal beams with the pre-distortion comprising pre-distorted phases and pre-distorted amplitudes that compensate for the distortion caused by at least one of the distortion medium, a manufacturing imperfection of the device, a temperature and/or stress induced variations of the device, an interaction with a target being imaged using the complex wavefront, or limitations in the field of view of the apertures.

4. The device of claim 3, further comprising one or more calibration processors coupled to the receiver processor and/or the complex transmitter waveform generator, wherein the signal beams comprise calibration signals having predetermined phases and predetermined amplitudes, and
the calibration processors determine the distortion comprising one or more changes in the predetermined phases and the predetermined amplitudes, and
the circuit applies the pre-distortion determined from the changes.

5. The device of claim 4, wherein the distortion comprises a phase shift and an amplitude shift that is canceled out by the pre-distorted phases and the pred-distorted amplitudes, respectively.

6. The device of claim 3, wherein:
the complex transmitter waveform generator comprises one or more calibration circuits downstream and/or upstream of the modulators, and
the calibration circuits comprise at least one of:
one or more detectors connected to measure one or more of the amplitudes of one or more of the signal beams, or
one or more in-phase (I) and quadrature (Q) interferometers connected to obtain measurements of one or more phases of one or more of the signal beams, and
the circuit confirms or controls the modulation of the pre-distorted phases and the pre-distorted amplitudes using the measurements as feedback.

7. The device of claim 6, wherein the detectors consist essentially of log 2(N) detectors for N signal beams.

8. The device of claim 6, wherein, for N>3 signal beams:
the calibration circuits connect to the signal beams via a first node, a second node, and a third node,
the first node is connected to the detectors comprising a single detector,
the second node is connected to a first one of the interferometers, and
the third node is connected to a second one of the interferometers, and
the calibration circuits cycle each of one or more of the signal beams to the three nodes.

9. The device of claim 4, wherein the coherent wavefront comprising the calibration signals:
is transmitted to a series of different points and the circuit determines the distortion comprising spatial variations in the phase and the amplitude between the different points, and
comprises a series of spectrally modulated waves (different in frequencies and/or relative phase) and the circuit determines the distortion comprising spectral shifts in the phases and the amplitudes.

10. The device of claim 9, wherein the modulators apply the pre-distortion according to:
calibration coefficients and matrices, or
corrections obtained from linear or nonlinear regression and optimization methods, or
corrections obtained from a machine learning algorithm.

11. A communication system comprising the device of claim 2 comprising one or more transmitters and one or more a receivers, wherein:
the signal beams carry data, and
the modulators are configured to frequency encode the signals so that the transceiver can send and receive different data from different directions simultaneously.

12. The device of claim 1 further comprising the transmitter and the receiver co-located on a single substrate.

13. The device of claim 2, comprising one or more transmitters and one or more receivers co-located on a single substrate, wherein the modulators and a coupling between the receiver and the transmitter modulate the signal beams to form the complex wavefront.

14. The device of claim 2, wherein the modulators modulate the signal beams to allow generation and processing of the complex wavefront comprising any arbitrary wavefront.

15. An imaging and/or beam forming system comprising the device of claim 2, comprising an optical phased array comprising:
the modulators modulating the signal beams; and
the aperture coherently combining the signal beams;
so as to form the complex wavefront and/or independently steer the signal beams.

16. The device of claim 2, wherein the apertures comprise an array of antennas or grating couplers and the power splitter comprises an array of waveguides.

17. The device of claim 2, wherein the modulators comprise:
a cascaded amplitude modulator and a phase modulator, or
an array of IQ modulators (SSB modulators).

18. The device of claim 1, wherein the receiver comprises:
a power splitter splitting the second portion of the coherent electromagnetic radiation into a plurality of reference signals and the mixer comprising an array of coherent IQ mixers connected to mix the received signals with the reference signals to form the mixed signals comprising downconverted IQ signals;
a modulator modulating the mixed signals to form modulated signals compensating for unwanted distortions caused by the receiver; and
one or more calibration circuits measuring the phase and amplitude of the modulated signals to control or confirm the compensating.

19. A photonic integrated circuit and/or one or more chips comprising the device of claim 1.

20. A photonic integrated circuit, comprising at least one of:
a transmitter and/or receiver comprising:
a power splitter comprising splitters positioned to split a plurality of beams (signal beams or reference beams) from an input comprising a first portion of coherent electromagnetic radiation received from a coherent source; and
a plurality of modulators positioned downstream of the power splitter to modulate a phase and amplitude of one or more of the beams received from the power splitter wherein:
the transmitter comprises a transmitter aperture positioned to transmit output electromagnetic radiation comprising the signal beams; and
the receiver comprises:
a receiver aperture positioned to output a plurality of received signals in response to the output electromagnetic radiation comprising the signal beams having interacted with a distortion medium; and
a mixer having a first input positioned to receive a second portion of the coherent electromagnetic radiation, a second input positioned to receive the received signals, wherein the mixer mixes the second portion with the received signals to form a plurality of mixed signals; and
a processor programmable to determine, from the mixed signals, a transmitted phase and a transmitted amplitude of one or more of the signal beams after interaction of the signal beams with a distortion medium; and
a circuit for controlling the modulators to form the signal beams with a pre-distortion comprising pre-distorted phases and pre-distorted amplitudes that compensate for a distortion caused by at least one of the distortion medium, a manufacturing imperfection of the device, a temperature and/or stress induced variations of the device, an interaction with a target being imaged using the complex wavefront, or limitations in the field of view of the apertures.
